(19) United States
(12) Patent Application Publication
(10) Pub. No.: US 2004/0124346 A1
(43) Pub. Date: Jul. 1, 2004

(54) RETRACTABLE SCANNER

(76) Inventor: SHIH-WEN CHEN, TAICHUNG (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,228

(22) Filed: Dec. 30, 2002

(51) Int. Cl. H01J 5/16

(52) U.S. Cl. 250/234

(57) ABSTRACT

A retractable scanner that is suited for scanning documents with different sizes. The retractable scanner comprises a first housing, a second housing, a fastening plate, a rolling element, a transparent sheet, and a scanning chassis. The second housing includes two side plates and a bottom plate, wherein the side plates and the bottom plate are connected with the first housing. The fastening plate is detachably connected with one of the first housing and the second housing. The rolling element is mounted in the first housing and the transparent sheet is wound on the rolling element. The transparent sheet can be dragged from the rolling element and then can be connected with the fastening plate such that a document can be placed on the transparent sheet. The scanning chassis is assembled in the first housing and it can reciprocally move under the transparent sheet.

### BACKGROUND OF INVENTION

1. Field of the Invention

The invention relates in general to an optical scanner. More particularly, the invention relates to a retractable scanner for scanning documents with different sizes.

2. Description of the Related Art

Nowadays, electronic products are increasingly used to achieve many various tasks. With the development of electronics technology, the principles of miniaturization, multi-function task, and comfort of utilization are the guidelines of electronic product manufacturers. As far as the profile of electronic products is concerned, lightness, thinness and smallness are the trends in design. Therefore, many optical scanners with different design styles have been researched. Analog images of words or patterns can be captured using an optical scanner, and then transformed into digital signals. As a result, after the process of transforming the analog images into the digital signals, an image file can beidentified, edited, saved or output by a computer or other device.

Sorted by type of inputting a document image, an optical scanner can be typed as a pocket scanner, a sheet feed scanner, a drum scanner, a flatbed scanner and so on. Among various optical scanners, the flatbed scanner is most popular because it has a stable scanning quality, has the functions of scanning reflection documents or transparency documents, and further is provided with an automatic document feeder (ADF) for scanning same-size documents.

FIG. 1 is a schematic top view of a conventional flatbed scanner. Referring to FIG. 1, a transparency plate 110, where a document is placed, is mounted on the top of a flatbed scanner 100. A transmission mechanism 120 assembled inside the scanner 100 is provided with a belt 122 and a motor 124, whereby a scanning chassis 130 inside the scanner 100 can be driven. A controlling unit 140, such as a printed circuit board serving as a controlling interface, is assembled inside the scanner 100 and is electrically connected with the motor 124 for controlling the operation of the motor 124. Besides the transmission mechanism 120 and the controlling unit 140, the conventional scanner 100 further includes a shaft 150 mounted in a housing 102 of the scanner 100 for controlling the moving path of the scanning chassis 130. A sleeve 132 mounted on the scanning chassis 130 fixedly receives the shaft 150. During scanning, the scanning chassis 130 driven by the transmission mechanism 120 is moved in the axial direction of the shaft. Therefore, the scanning chassis 130 can be reciprocally moved under the transparency plate 110 to perform a scanning operation.

However, the conventional scanner is only of one size, and generally is suited for scanning an A4 size document, so its volume is very large and it is not convenient to carry it. If the scanner is modified to bea smaller size, it can be comfortably carried and can scan small-size documents, such as business cards and photographs, but it cannot scan large-size documents.

### SUMMARY OF INVENTION

Accordingly, an objective of the present invention is to provide a retractable scanner that can expand or retract in many different sizes to be fitted to the documents with different sizes. Moreover, after the scanner is retracted, it is small enough to be comfortably carried.

To achieve the foregoing and other objectives, the present invention provides a retractable scanner that is suited for scanning documents with different sizes. The retractable scanner comprises a first housing, a second housing, a fastening plate, a rolling element, a transparent sheet, and a scanning chassis. The second housing includes two side plates and a bottom plate, wherein the side plates and the bottom plate are connected with the first housing. The fastening plate is detachably connected with one of the first housing and the second housing. The rolling element is mounted in the first housing and the transparent sheet is wound on the rolling element. The transparent sheet can be dragged from the rolling element and then can beconnected with the fastening plate such that a document can be placed on the transparent sheet. The scanning chassis is assembled in the first housing and it can reciprocally move under the transparent sheet.

According to a preferred embodiment of the present invention, the side plates and the bottom plate of the second housing are connected with the first housing by pivots. The side plates and the bottom plate can be flipped on outer surfaces of the first housing. In addition, the side plates and the bottom plate of the second housing also can be detachably connected with the first housing.

In addition, the scanning chassis is provided with many rollers and the first housing has manyfirst grooves and each of the rollers is inserted into one of the first grooves. The second housing has many second grooves and each of the second grooves is connected with one of the first grooves. The retractable scanner further includes a driving device, such as a motor, that is mounted at the scanning chassis and can drive the rollers to rotate. The retractable scanner further includes a controlling unit, such as a printed circuit board serving as a controlling interface, that is mounted in the first housing and is electrically connected with the driving device.

Moreover, the retractable scanner further includes a fastening assembly comprising a first fastening portion and a second fastening portion. The first fastening portion is positioned at an end of the transparent sheet. The second fastening portion is positioned at a top end of the fastening plate. After the transparent sheet is dragged from the rolling element, the first fastening portion of the transparent sheet can be connected with the second fastening portion of the fastening plate.

Besides, the retractable scanner further includes a first signal line mounted in the first housing and a second signal line mounted in the second housing. An end of the first signal line is electrically connected with the controlling unit. An end of the second signal line can be selectively electrically connected with the first signal line to form a loop circuit.

Both the foregoing general description and the following detailed description are exemplary and explanatory only and are not restrictive of the invention, as claimed. It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. A simple description of the drawings is as follows.

FIG. 1 is a schematic top view of a conventional flatbed scanner.

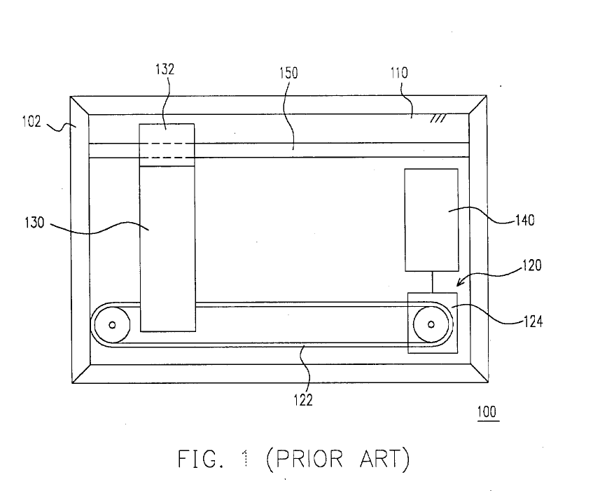

FIG. 2 is a schematic perspective view of a retractable scanner according to an embodiment of the present invention.

FIG. 3 is a schematic top view of a retractable scanner according to an embodiment of the present invention.

FIG. 4 is a schematic top view of a retractable scanner according to an embodiment of the present invention.

### DETAILED DESCRIPTION

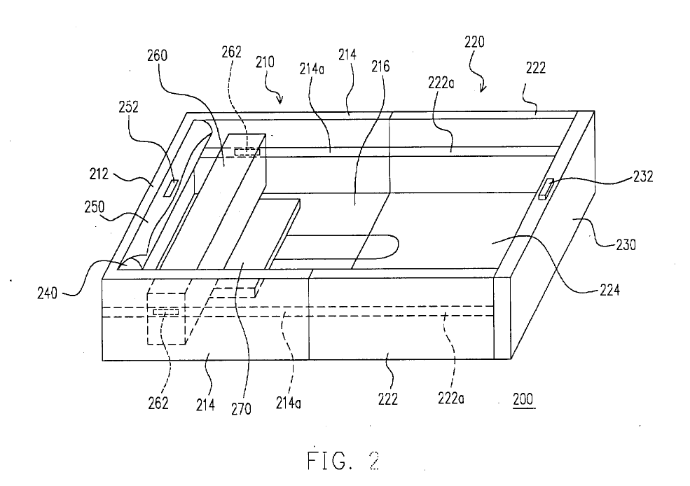

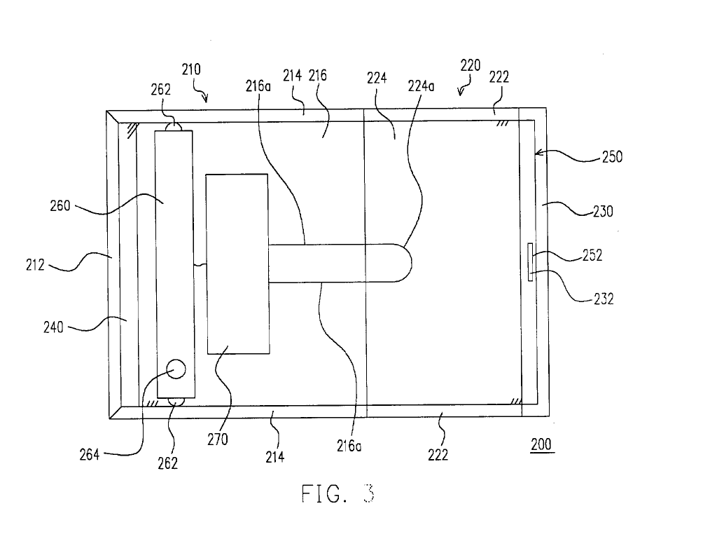

FIG. 2 is a schematic perspective view of a retractable scanner according to an embodiment of the present invention. FIG. 3 is a schematic top view of a retractable scanner according to an embodiment of the present invention. Referring to FIG. 2 and FIG. 3, an optical scanner 200 suited for scanning documents with different sizes includes a first housing 210, a second housing 220, a fastening plate 230, a rolling element 240, a transparent sheet 250 and a scanning chassis 260. The first housing 210 is constructed from the connection among a front plate 212, two side plates 214 and a bottom plate 216. The second housing 220 is constructed from two side plates 222 each having one end portion to be connected with one of the side plates 214 of the first housing 210 by a pivot and a bottom plate 224 having one end portion to be connected with the bottom plates 216 of the first housing 210 by a pivot. The side plates 222 and the bottom plate 224 can be flipped onto the outer surfaces of the first housing 210. The fastening plate 230 can be detachably connected with the end portion of the first housing 210, which is connected with the second housing 220 by pivots, or can be detachably connected with a tail portion of the second housing 220

The rolling element 240 is mounted in the first housing 210 and the transparent sheet 250 is wound on the rolling element 240. The transparent sheet 250 can be dragged from the rolling element 240 and then can be connected with the fastening plate 230 by a fastening assembly. The fastening assembly is constructed from a first fastening portion 252, such as an opening, positioned at a front end of the transparent sheet 250 and a second fastening portion 232, such as a bump, positioned at a top end of the fastening plate 230. After the transparent sheet 250 is dragged from the rolling element 240, the first fastening portion 252 of the transparent sheet 250 can be connected with the second fastening portion 232 of the fastening plate 230 and, thus, a document can be placed on the transparent sheet 250.

The scanning chassis 260 is assembled in the first housing 210 and two rollers 262 are assembled respectively on two side surfaces of the scanning chassis 260. Each of the two side plates 214 of the first housing 210 has a first groove 214a and the two rollers 262 of the scanning chassis 260 are inserted into the two first grooves 214a of the first housing 210 respectively. Besides, a driving device 264, such as a motor, that can drive the rollers 262 to rotate is mounted at the scanning chassis 260. Moreover, each of the two side plates 222 of the second housing 220 has a second groove 222a and the two second grooves 222a correspond to the two first grooves 214a respectively. When the side plate 222 of the second housing 220 is flipped to be coplanar with the side plate 214 of the first housing 210, the first grooves 214acommunicate with the corresponding second grooves 222a respectively. The roller 262 assembled on the scanning chassis 260 can move along the first grooves 214aand then can move along the second grooves 222a such that the scanning chassis 260 can move from the inside of the first housing 210 to the inside of the second housing 220.

A controlling unit 270, such as a printed circuit board serving as a controlling interface, is mounted on the bottom plate 216 of the first housing 210 and is electrically connected with the driving device 264 for controlling the operation of the driving device 264.

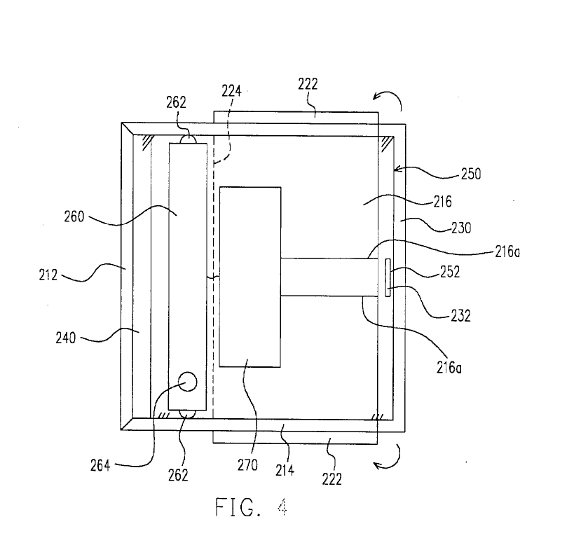

FIG. 4 is a schematic top view of a retractable scanner according to an embodiment of the present invention. Referring to FIG. 3 and FIG. 4, when the scanner 200 is to be retracted, first, the first fastening portion 252 is unfastened from the second fastening portion 232 so that the transparent sheet 250 is separated from the fastening plate 230. Next, the fastening plate 230 is detached from the second housing 220. Subsequently, the side plates 222 and the bottom plate 224 of the second housing 220 are flipped on the outer surfaces of the first housing 210. Afterwards, the fastening plate 230 is mounted on the end portion of the first housing 210, which is connected with the second housing 220 by pivots. Finally, the transparent sheet 250 is dragged from the rolling element 240 to the fastening plate 230. This completes the operation of contracting the scanner 200.

It is should be noted that the second housing is not limited to a single set as described in the above-mentioned embodiment, but the scanner also can be provided with many second housings sequentially connected one to another. Therefore, the scanner has more than two sizes. In addition, it is not limited that the second housing is connected with the first housing by pivots, but only that the second housing can be detachably connected with the first housing. In other words, when a large-size document is to be scanned, the second housing is assembled with the first housing; when a small-size document is to be scanned, the second housing is detached from the first housing.

Referring to FIG. 3 and FIG. 4, a method of determining a scanning region of the retractable scanner according to the present invention is provided. A first signal line 216a is mounted on the bottom plate 216 of the first housing 210 and one end of the first signal line 216a is electrically connected with the controlling unit 270. A second signal line 224a is mounted on the bottom plate 224 of the second housing 220. When the bottom plate 224 of the second housing 220 is flipped to be coplanar with the bottom plate 216 of the first housing 210, the second signal line 224a is electrically connected with the first signal line 216a and a loop circuit is formed. When the bottom plate 224 of the second housing 220 is flipped on the outer surfaces of the first housing 210, an open circuit is formed between the second signal line 224a and the first signal line 216a. Therefore, before a scanning operation is performed, in the case where the controlling unit 270 receives a signal response from the loop circuit formed by the second signal line 224a and the first signal line 216a, the controlling unit 270 determines the scanning region of the retractable scanner 200 is a large one. In case any signal response from the second signal line 224a is not received by the controlling unit 270, the controlling unit 270 determines that the scanning region of the retractable scanner 200 is a small one.

In addition to the scanning region of the retractable scanner being determined by receiving a signal response or not from the first signal line, the scanning region of the retractable scanner also can be determined by a user's selection at the retractable scanner or at a computer connected with the retractable scanner.

To sum up, the present invention has the following advantages:

1. According to the present invention, the scanner can be expanded or retracted, so the size of the retractable scanner can be changed to fit the size of the document. Therefore, the retractable scanner has powerful functionality and practicality.

2. According to the present invention, the scanning region of the retractable scanner can be automatically determined by the loop circuit or the open circuit of the signal lines or can be manually determined by the user's selection at the retractable scanner or at a computer. Therefore, the operation of determining the scanning region is comfortable and easy.

3. According to the present invention, after the scanner is retracted, it is small enough to be comfortably carried.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A retractable scanner, suited for scanning documents with different sizes, comprising:
a first housing;
a second housing including two side plates and a bottom plate, the side plates and the bottom plate being connected with the first housing;
a fastening plate detachably connected with one of the first housing and the second housing;
a rolling element mounted in the first housing;
a transparent sheet wound on the rolling element, the transparent sheet being capable of being dragged from the rolling element and then being capable of being connected with the fastening plate, and a document being capable of being placed on the transparent sheet; and
a scanning chassis assembled in the first housing and the scanning chassis being capable of reciprocally moving under the transparent sheet.

2. The retractable scanner according to claim 1, wherein the scanning chassis is provided with a plurality of rollers and the first housing has a plurality of first grooves, each of the rollers being inserted into one of the first grooves.

3. The retractable scanner according to claim 2, wherein the second housing has a plurality of second grooves and each of the second grooves is connected with one of the first grooves.

4. The retractable scanner according to claim 2, further includes a driving device that is mounted at the scanning chassis and can drive the rollers to rotate.

5. The retractable scanner according to claim 4, wherein the driving device is a motor.

6. The retractable scanner according to claim 4, further includes a controlling unit that is mounted in the first housing and is electrically connected with the driving device.

7. The retractable scanner according to claim 6, wherein the controlling unit is a printed circuit board.

8. The retractable scanner according to claim 1, further includes a fastening assembly comprising:
a first fastening portion positioned at an end of the transparent sheet; and
a second fastening portion positioned at a top end of the fastening plate, wherein after the transparent sheet is dragged from the rolling element, the first fastening portion of the transparent sheet can be connected with the second fastening portion of the fastening plate.

9. The retractable scanner according to claim 6, further includes a first signal line that is mounted in the first housing and an end of the first signal line is electrically connected with the controlling unit.

10. The retractable scanner according to claim 9, further includes a second signal line that is mounted in the second housing and an end of the second signal line can be selectively electrically connected with the first signal line to form a loop circuit.

11. The retractable scanner according to claim 1, wherein the side plates and the bottom plate of the second housing are connected with the first housing by pivots, and the side plates and the bottom plate can be flipped on outer surfaces of the first housing.

12. The retractable scanner according to claim 1, wherein the side plates and the bottom plate of the second housing are detachably connected with the first housing.
